(19) United States
(12) Patent Application Publication
(10) Pub. No.: US 2004/0248642 A1
(43) Pub. Date: Dec. 9, 2004

(54) Adaptable gaming machine in a gaming network

(76) Inventor: Wayne H. Rothschild, Northbrook, IL (US)

Correspondence Address: JENKENS & GILCHRIST, P.C., 225 WEST WASHINGTON, SUITE 2600, CHICAGO, IL, 60606, US

(21) Appl. No.: 10/850,993

(22) Filed: May 21, 2004

Related U.S. Application Data
(60) Provisional application No. 60/473,854, filed on May 28, 2003.
(60) Provisional application No. 60/528,384, filed on Dec. 10, 2003.

(51) Int. Cl. A63F 13/00

(52) U.S. Cl. 463/20

(57) ABSTRACT

In a server-based gaming network including a number of gaming machines communicatively coupled to one or more servers, an adaptable electro-mechanical gaming machine having an electro-mechanical device and an optional variable display device(s) coupled to a controller. The configuration of the adaptable electro-mechanical gaming machine is substantially or partially controlled via feature options. Selection of the feature options may be made by the adaptable electro-mechanical gaming machine or by a coupled apparatus. The feature options may reside on the adaptable electro-mechanical gaming machine or on a coupled apparatus, and may include hold percentage configurations, game play denominations, minimum wager amounts, top award configurations, bonus game schemes, player specific bonus features, mechanical device motion profiles, electronic transfer fund configurations, game theme configurations, lighting configurations, sound configurations, harm minimization behaviors, and casino float configurations. Thus, the adaptable electro-mechanical gaming machine can be automatically configured with or without manual intervention.

### RELATED APPLICATIONS

This application is related to and claims priority to U.S. Provisional Patent Application Ser. No. 60/473,854, filed May 28, 2003, titled “Adaptable Mechanical Spinning Reel Slot Machine In a Server Based Gaming Network,” and to U.S. Provisional Patent Application Ser. No. 60/528,384, filed Dec. 10, 2003, titled “Adaptable Electro-Mechanical Gaming Machine In a Server-Based Gaming Network,” each of which is incorporated herein in its entirety.

### FIELD OF THE DISCLOSURE

This invention is directed to a gaming network, and more particularly, to an adaptable electro-mechanical gaming machine in a gaming network.

### BACKGROUND

Gaming machines providing games such as electronically driven video slots, video poker, video blackjack, video keno, video bingo, video pachinko, video lottery, and mechanically driven spinning reel slots, etc., are well known in the gaming industry. Traditionally, gaming machines were configured to operate as “stand-alone” units (that may or may not have been continuously coupled or event driven coupled to a backroom computer) where the outcome of game play was “locally determined” by the gaming machine. Recently, however, in addition to operating as stand-alone units, gaming machines have been communicatively coupled to one or more servers forming a “server-based gaming network.” Current server-based gaming networks typically include a number of gaming machines, communicatively coupled via a dedicated (i.e., non-public) communication network to one or more servers (“coupled servers”). Current server-based gaming network configurations provide easy access to gaming machine data including gaming machine performance data, player tracking data, accounting data, security data, and maintenance data, as examples.

When coupled to one or more servers, game outcome of video game play on a gaming machine may be determined either centrally or locally (1) by using a random number generator (RNG) resulting in a pseudo-random set of outcomes, or (2) by selecting a game outcome from a fixed set of outcomes (pooled), or (3) by employing another suitable scheme. For example, in the case of a “centrally determined” outcome, game outcome may be determined by a coupled server having a RNG, or may be determined by a coupled server utilizing a pooling scheme. For a locally determined outcome, game outcome may be determined by the gaming machine having an RNG, however, the coupled server may provide enhancements such as community progressive games, community bonus games, tournaments, etc.

With the exception of wide area progressive (WAP) configurations, the benefits from utilizing server-based gaming networks, such as software download capability, variable game play capability, and central outcome determination capability, have typically been associated with gaming machines offering video games such as video slots, video bingo, etc., and not with electro-mechanical gaming machines such as mechanical reel spinning slot machines. This is due in part to the ease with which video games may be updated or changed via a coupled server in a server-based gaming network. For example, changing the video reel symbols on a video based slot game may be accomplished by downloading the appropriate software from the coupled server to the gaming machine. In order to change or alter a reel spinning slot machine, however, the physical reel strips bearing the reel symbols must be manually removed and replaced. Similarly, in order to alter other motor driven game elements or mechanical devices on gaming machines, for example, wheels, dice, etc., the mechanical device must be manually removed and replaced. Moreover, changing return-to-player percentages, minimum bet denominations, etc., in a mechanical reel spinning slot machine requires manual replacement of memory devices such as EPROMs and possibly manual replacement of the pay table glass and reel glass, among other things.

### SUMMARY OF THE INVENTION

One aspect of the present invention provides an adaptable electro-mechanical gaming machine coupled to an apparatus (a “coupled apparatus”) in a gaming network. The coupled apparatus includes a coupled apparatus controller and may be a server, another gaming machine, a handheld computer, or any other suitable apparatus. The adaptable electro-mechanical gaming machine includes a feature option and at least one electro-mechanical device coupled to a gaming machine controller of the adaptable electro-mechanical gaming machine.

Another aspect of the present invention provides an electro-mechanical gaming machine in a gaming network. In one embodiment, operation of the adaptable electro-mechanical gaming machine may be substantially controlled by a server coupled to the adaptable electro-mechanical gaming machine (“coupled server”). In that case, the coupled server detects a wager to play the slot game, determines the value payout of the slot game and causes the symbol-bearing reels of the adaptable electro-mechanical gaming machine to rotate and stop to place the symbols in a symbol array yielding the value payout. If the value payout indicates an award to the player, a winning symbol combination associated with the award is included in the symbol array. In addition, if provided on the adaptable electro-mechanical gaming machine, one or more variable display devices(s) may display images before, during, and after slot game play, where the images are selected by the coupled server. The image may include instructional information graphics, pay line graphics, symbol graphics, bonus game graphics, jackpot graphics, special effects graphics, theme graphics, bonus event graphics, pay table graphics, etc. Further, more than one variable display may be provided on the adaptable electro-mechanical gaming machine.

In another embodiment, operation of the adaptable electro-mechanical gaming machine may be partially controlled by a coupled apparatus. In that case, the adaptable electro-mechanical gaming machine receives a wager to play the slot game. In response to the wager received by the adaptable electro-mechanical gaming machine, the coupled apparatus determines a value payout of the slot game. Based on the value payout determined by the coupled apparatus, the adaptable electro-mechanical gaming machine causes the symbol-bearing reels to rotate and stop to place the symbols in a symbol array yielding the value output. The symbol array is selected by the adaptable electro-mechanical gaming machine from among a plurality of symbol arrays yielding the server-determined value payout. If the value payout indicates an award to the player, a winning symbol combination associated with the award is included in the symbol array. In addition, if provided on the adaptable electro-mechanical gaming machine, one or more variable display device(s) may display images before, during, and after slot game play, where the images are selected by the coupled server.

In still another embodiment, operation of the adaptable electro-mechanical gaming machine is substantially controlled by the coupled apparatus. Therefore, the coupled apparatus controller is programmed to configure the feature option, to determine a value payout in response to detecting a wager made by a player of the adaptable electro-mechanical gaming machine, and to display, on the electro-mechanical device, an outcome associated with the value payout. Configuration of the feature option may include selecting one or more feature options from among a plurality of feature options.

In yet another embodiment, a configuration (and therefore operation) of the adaptable electro-mechanical gaming machine may be controlled by the adaptable electro-mechanical gaming machine based on selected feature options previously downloaded from a coupled server. The feature options, either individually or collectively, determine game aspects of the adaptable electro-mechanical gaming machine and therefore include hold percentages, return-to-player percentage configurations, slot game play denominations, minimum wagering amounts, a number of top awards and their associated winning symbol combinations, bonus award schemes, game themes, including game theme graphics, images, lighting and sound configurations, etc. In that case, the adaptable electro-mechanical gaming machine selects one or more feature options. Selection of the one or more feature options may be based on one of any number of triggering events such as a time of day, a day of the week, a promotional scheme, a player identity and associated preferences, a player selection (e.g., selecting a particular themed slot game from among a number of themed slot games), etc.

Upon receiving a wager to play the slot game the adaptable electro-mechanical gaming machine determines a value payout of the slot game. Based on the value payout, the adaptable electro-mechanical gaming machine then causes the symbol-bearing reels to rotate and stop to place the symbols in a symbol array. Thus, both the value payout and symbol array are selected by the adaptable electro-mechanical gaming machine, previously configured using the selected feature options. In addition, if provided on the adaptable electro-mechanical gaming machine, one or more variable display devices(s) may display images before, during, and after slot game play, where the images are selected by the adaptable electro-mechanical gaming machine (if previously downloaded by the coupled server).

In a further embodiment, operation of the adaptable electro-mechanical gaming machine is substantially controlled by the adaptable electro-mechanical gaming machine. Therefore, the gaming machine controller is programmed to receive a plurality of feature options from the coupled apparatus, to select the feature option from among of the plurality of feature options, to determine a value payout in response to detecting a wager made by a player of the adaptable electro-mechanical gaming machine, and to display, on the electro-mechanical device, an outcome associated with the value payout.

In still a further embodiment, a configuration of adaptable electro-mechanical gaming machine may be controlled by a coupled server or another gaming machine based on one or more features options selected by the coupled server or the other gaming machine(s). The one or more feature options are selected from among a plurality of feature options which may be stored in a memory device (e.g., CD ROM, DVD, hard drive, compact flash memory, etc.) of the adaptable electro-mechanical gaming machine or may be downloaded from a suitably configured server or other gaming machine. In that case, the coupled server or another gaming machine selects one or more of the feature options. Selection of the one or more of the feature options may be based on one of any number of triggering events discussed above.

Upon receiving a wager to play the slot game, the adaptable electro-mechanical gaming machine determines a value payout of the slot game. Based on the value payout, the adaptable electro-mechanical gaming machine then causes the symbol-bearing reels to rotate and stop to place the symbols in a symbol array. Thus, both the value output and symbol array are selected by the adaptable electro-mechanical gaming machine previously configured using feature options selected by the coupled server or another gaming machine. In addition, if provided on the adaptable electro-mechanical gaming machine, one or more variable display device(s) may display images before, during, and after slot game play, where the images are selected by the coupled server.

In yet another embodiment, operation of the adaptable electro-mechanical gaming machine is partially controlled by the coupled apparatus. Therefore, the coupled apparatus controller is programmed to select the feature option from among a plurality of feature options while the gaming machine controller is programmed to determine a value payout in response to detecting a wager made by a player of the adaptable electro-mechanical gaming machine, and to display, on the electro-mechanical device, an outcome associated with the value payout.

In some embodiments, the electro-mechanical device may be a plurality of mechanical spinning reels having reels symbols thereon, or may be one of any motor-driven game element such as dice, flip cards, a wheel, etc. There may also be more than one electro-mechanical device on the adaptable electro-mechanical gaming machine.

A wagering game aspect of the adaptable electro-mechanical gaming machine is determined by the feature option. The feature option may include hold percentage configurations, game play denominations, minimum wager amounts, top award configurations, bonus game schemes, player specific bonus features, mechanical device motion profiles, electronic transfer fund configurations, game theme configurations, lighting configurations, sound configurations, harm minimization behaviors, and casino float configurations.

If the feature option is an electronic transfer fund configuration, a player electronic transfer fund may be established at the adaptable electro-mechanical gaming machine. Alternatively, if the feature option is the electronic transfer fund configuration, the player electronic transfer fund may be established at the coupled apparatus.

The adaptable electro-mechanical gaming machine may optionally include a variable display device adapted to display a plurality of graphics on the adaptable electro-mechanical gaming machine. The plurality of graphics displayed on the variable display device may be selected by the adaptable electro-mechanical gaming machine or the coupled apparatus. The plurality of graphics may include instructional information graphics, pay line graphics, symbol graphics, bonus game graphics, jackpot graphics, special effects graphics, theme graphics, bonus event graphics and pay table graphics. The variable display device is preferably a flat panel transmissive display or a light emitting diode display.

If the adaptable electro-mechanical gaming machine includes a variable display device, the feature option may further include a plurality of graphics configuration, an attract mode configuration, an advertising configuration, or an additional game graphic.

Selection or configuration of the feature options by either the gaming machine controller or the coupled apparatus controller may be based on an occurrence of an event where the event can include a time of day, a day of a week, a promotional activity, a local activity, an identity of the player, a selection made by a player, or a selection made by a gaming operator.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a block diagram of an embodiment of a server-based gaming system in accordance with the invention.

FIG. 2 is a perspective view of an embodiment of one of the gaming machines shown schematically in FIG. 1.

FIG. 3 is a perspective view of another embodiment of one of the gaming machines having mechanical spinning reels shown schematically in FIG. 1.

FIG. 4 is a block diagram of the electronic components of one or more gaming machines of the server-based gaming system of FIG. 1.

FIG. 5 is a flat view of an exemplary fixed configuration reel strip of a mechanical spinning reel of the gaming machine of FIG. 3.

FIG. 6 is an exemplary award glass display of a gaming machine having mechanical spinning reels.

FIG. 7 is an exemplary belly glass display of a gaming machine having mechanical spinning reels.

FIG. 8 a flowchart of an exemplary image modification routine that may be performed by the server(s) and the gaming machines of FIG. 1.

FIG. 9 is a flowchart of an exemplary player-initiated modification routine that may be performed by the server(s) and the gaming machines of FIG. 1.

FIG. 10 is a flowchart of an embodiment of a slot routine that may be performed by one or more of the gaming machines of FIG. 1.

### DESCRIPTION OF THE PREFERRED EXAMPLES

The description of the preferred examples is to be construed as exemplary only and does not describe every possible embodiment of the invention. Numerous alternative embodiments could be implemented, using either current technology or technology developed after the filing date of this patent, which would still fall within the scope of the claims defining the invention.

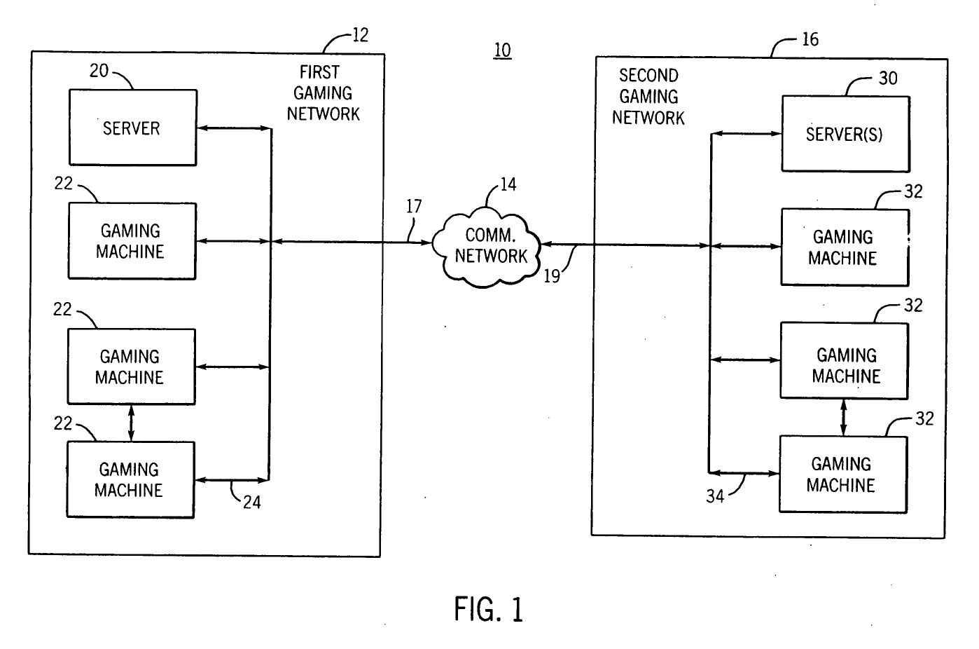

FIG. 1 is a block diagram of a server-based gaming system 10 in accordance with the invention. Referring to FIG. 1, the server-based gaming. system 10 includes a first gaming network 12 operatively coupled to a communication network 14 via a first network link 17, and a second gaming network 16 operatively coupled to the communication network 14 via a second network link 19. The communication network 14 may be a public communications network, for example, the Internet, or may be a dedicated private network, for example, an intranet. The communication network may be configured in any number of ways including a local area network (LAN) or a wide area network (WAN). If configured as an intranet LAN or WAN, the communication network 14 may be implemented using a dedicated hardwired systems (e.g., private leased phone lines) or a wireless system (e.g., private microwave or satellite links, or wireless links) using any number of topologies including a ring topology, a tree topology, a full or partial mesh topology, etc., and the communication network 14 may include a conventionally known secure network interface for providing security against unauthorized access. If configured to include an Internet portion, the communication network 14 may accommodate virtual private network (VPN) tunneling protocols between the first and second gaming networks 12, 16 via the first and second network links 17, 19. The communication network 14 and the first and second gaming networks 12, 16 may also include additional network elements such as routers, firewalls, servers, controllers, switches, etc. to accommodate variations in network interfaces. Although two gaming networks are shown in the illustrated example, it is contemplated that the gaming system 10 may include only one gaming network.

The first and second gaming networks 12, 16 may be co-located in a first casino location. Alternatively the first gaming network 12 may be located in the first casino while the second gaming network may be located in a second casino that may or may not be in the same geographic region. For example, the first and second gaming networks 12, 16 may be located in different casinos in Las Vegas. In another example, the first gaming network 12 may be provided in a casino located in St. Louis while the second gaming network 16 may be provided in a casino located in Chicago. In other words, the first and second gaming networks 12, 16 may be located in any suitable geographic region and may be interconnected via a dedicated communication network, a secure public communication network (discussed below), or a combination of both.

In the illustrated example, the first gaming network 12 includes three gaming machines 22 interconnected to a server 20 (“coupled server”) via a bus or data link 24. The data link 24 is communicatively coupled to the first network link 17. Similarly, the second gaming network 16 includes three gaming machines 32 interconnected to a coupled server 30 via a bus or data link 34. The data link 34 is communicatively couple to the second network link 19. The data links 24, 34 may be configured using copper wire cable, fiber optic cable, an optical wireless link or any other suitable link capable of transmitting and receiving data, such as a conventional RF or WiFi wireless link. In addition, the connection enabled via the data links 24, 34 may be continuous or intermittent (e.g., event driven), depending on the desired configuration. Thus, gaming software and gaming data can be transmitted between and among the first and second gaming networks 12, 16.

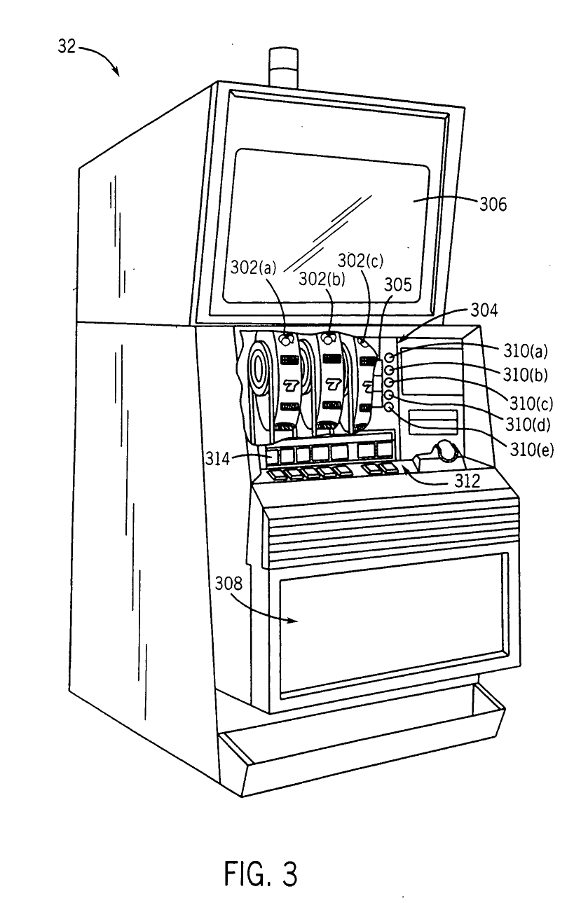

The gaming machines 22, 32 may be configured in any number of ways and may provide any number base games (e.g., mechanically driven spinning reel slots, video slots, video poker, video blackjack, video keno, video bingo, video pachinko, and video lottery) and/or bonus games (e.g., Hollywood Squares, Reel 'Em In, Monopoly Money, etc.). For example, the gaming machine 22 may be configured as a video slot machine while the gaming machine 32 may be configured as an adaptable spinning reel slot machine (discussed in connection with FIG. 3).

The base and bonus games may reside directly on memory devices within the gaming machines 22, 32. In addition, the feature options such as hold percentage configurations, game play denomination configurations, minimum wager amount configurations, top award configurations, bonus game scheme configurations, player specific bonus feature configurations, mechanical device motion profiles, electronic transfer fund configurations, game theme configurations, lighting configurations, sound configurations, harm minimization behavior configurations, casino float configurations, graphics configurations, attract mode configurations, advertising graphics, and game graphic configurations may reside directly on the memory devices within the gaming machines 22, 32. Alternatively, the base games, the bonus games, and the feature options may be downloaded from high capacity storage devices such as CD ROMs, DVDs, hard drives, compact flash memory, etc., or may be downloaded from the coupled servers 20, 30 using suitable authentication and/or encryption techniques (discussed below). The base games, the bonus games and/or the feature options may also be executed by the coupled servers 20, 30 and displayed on the gaming machines 22, 32.

The coupled servers 20, 30 may be configured as network computers to accumulate and analyze gaming data using data mining or other suitable techniques. The gaming data may include, among other things, gaming machine performance data, maintenance information and instructions, maintenance data, security data, player data, accounting data, percentage hold data, slot game plays denomination data, minimum wager amount data, top award data, bonus award scheme data, lighting configuration data, sound configuration data and game outcome data (for gaming networks having central determination). Like the gaming machines 22, 32, the coupled servers 20, 30 may also be configured with the gaming machine software, game outcome software (RNG, pooled, etc.), the base games, and the bonus games, etc.

If the server-based gaming system 10 includes an Internet portion, the coupled servers 20, 30 may include virtual private network (VPN) application software and be configured to execute VPN tunneling protocols (e.g., IPsec, point-to-point tunneling protocol (PPTP), secure shell (SSH), proprietary protocols, secure Internet and/or network protocols and future Internet tunneling protocols). The coupled servers 20, 30 may also include cryptographic software to enable secure transmission of the gaming machine software, the base games, the bonus games, and any other associated data. Such cryptographic software may be used to generate random numbers for use in a variety of security applications; message authentication codes (MACs), one-way hash algorithms, public/private-key schemes, digital signature schemes, symmetric encryption/decryption schemes, etc. Thus, if desired, the gaming machine software, the base games and the bonus games may be downloaded from the coupled servers 20, 30 to the gaming machines 22, 32.

Although shown having three gaming machines and one server, the first and second gaming networks 12, 16 may include more or less gaming machines and/or servers, depending on the desired configuration and functionality. For example, the first gaming network 12 may include thousands of gaming machines (providing hundreds of different games) interconnected to many servers (providing a variety of functions) via the first data link 24. In addition, although not shown, the first and second gaming networks 12, 16 may also include additional devices such as firewalls for perimeter defense, security servers to administer access control to the first and second gaming networks 12, 16, etc. For example, the first and second gaming networks may each include a security server configured to perform data integrity assurance functions, intrusion detection functions, antivirus functions, security report generation, etc.

Gaming Machines

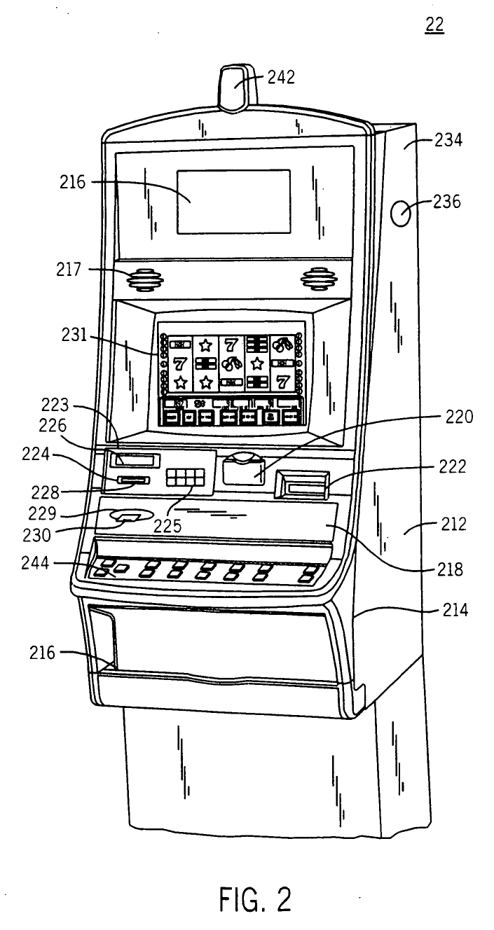

FIG. 2 is a perspective view of one possible embodiment of the gaming machines of FIG. 1 such as the gaming machine 22. The gaming machine 22 can be any type of casino video gaming machine and may therefore have varying structures and methods of operation. For example, the gaming machine 22 can be a video game such as blackjack, slots (with or without arm mechanism), keno, poker, a video lottery game, any number of class II or class III games defined by the Indian Gaming Regulatory Act (IRGA), and so on. For exemplary purposes, various elements of the gaming machine 22 are described below, but it should be understood that numerous other elements may exist and may be utilized in any number of combinations to create a variety of gaming machine types.

Referring to FIG. 2, the casino gaming machine 22 includes a cabinet 212 having a door 214 on the front of the gaming machine 22. The door 214 provides access to the interior of the gaming machine 22. Audio speaker(s) 217 and belly glass 218 that enable themed auditory and visual effects to be added to the gaming experience may be attached to the door 214. The audio speaker(s) 217 may generate audio representing sounds such as the noise of spinning slot machine reels, a dealer's voice, music, announcements or any other audio related to a casino game. Visual effects, including flashing or other patterns displayed from lights behind the belly glass 218, may attract a player to the game and may enhance player excitement.

There may be a number of value input devices also attached to the door 214 (discussed below). Value input devices may include any device that can accept value from a customer. For example, the value input devices may include a coin acceptor 220 or a note acceptor 222 to input value to the gaming machine 22. The note acceptor 222 accepts value in any number of forms, including currency or a currency-sized paper ticket voucher inscribed with information such as a bar code representing value, the name of the casino, the date, etc. As used herein, the term “value” may encompass gaming tokens, coins, paper currency, ticket vouchers, credit or debit cards, smart cards, and any other object representative of value.

The gaming machine 22 may also include a player tracking area 223 having a card reader 224, a keypad 225 and a display 226. As will be appreciated by those of ordinary skill in the art, the player tracking area 223 may be located in any number of areas of the gaming machine 22. The display 226 may be configured using a vacuum fluorescent display (VFD), a liquid crystal display (LCD), etc. that may or may not include a touch screen, and can be used to display information to a game player or casino employee. The card reader 224 may be any type of card reading device, such as a magnetic card reader, smart card reader or an optical card reader. Typically, the card reader 224 is used to read data from an appropriate card (e.g., a credit card, a player tracking card, or a smart card) inserted by a player. If provided for player tracking purposes, the card reader 224 may be used to read data from, and/or write data to, player tracking cards capable of storing data. Such data may include the identity of a player, the identity of a casino, the player's gaming habits, etc. Once gathered via the card reader 224 (or from a suitable device of the server-based gaming network 10), the data may be “mined” (i.e., the data is sorted to identify patterns and establish relationships) for any number of purposes including administering player awards, distinguishing player preferences and habits, accounting, etc.

The card reader 224 may also be used by casino personnel (e.g., a slot technician) as part of a process to gain access to the gaming machine in order to perform tasks such as coin collection, hopper filling, etc. In that case, the casino employee may be required to enter an identifying code, for example a PIN number, via the keypad 225. Similarly, the keypad 225 may also be used by the casino employee to enter additional information regarding the task. In this way, access to the interior of the gaming machine 22 is monitored. Alternatively or additionally, a biometric device may be used for ascertaining the identity of a player or operator (such as a casino employee).

If provided on the gaming machine 22, a ticket printer 229 is configured to print or otherwise encode ticket vouchers 230 with the casino name, the type of ticket voucher, a validation number, a bar code with control and/or security data, the date and time of issuance of the ticket voucher, redemption instructions and restrictions, a description of an award, and/or any other information that may be necessary or desirable. A variety of types of ticket vouchers 230 could be used, such as casino chip ticket vouchers, cash-redemption ticket vouchers, bonus ticket vouchers, extra game play ticket vouchers, merchandise ticket vouchers, restaurant ticket vouchers, show ticket vouchers, etc.

The gaming machine 22 also includes a video display 231 for displaying images relating to the game or games provided by the gaming unit 22. The video display 231 may be a cathode ray tube (CRT), a high resolution LCD including an LCD-TFT display, a plasma display, or any other type of video display suitable for use in a gaming machine. The video display 231 may be configured to provide animation, 2-D or 3-D images, digital video playback, and or any number of other suitable displays. An information table typically includes general game information such as game denominations (e.g., $0.25, $1, $5) and pay line options. In the alternative, the gaming machine 22 may also include a number of mechanical reels or other electro-mechanical game play devices viewable through the door 214.

The gaming machine 22 may also include a box top 234 configured to intensify player excitement through the use of additional speaker(s) 236, a bonus video display screen 216, an LED display and an optional microphone (not separately illustrated) and an optional camera (not separately illustrated). The bonus video display screen 216, configured as a backlit silk screen panel, painted artwork, an LCD screen, or a video monitor, can enable a number of game enhancements such as bonus games, tournament games, progressive jackpot games, etc. The LED display can display additional game enhancements such as an accumulated jackpot award amount. In addition, a tower light or candle 242 mounted atop the gaming machine 22 may be included to provide a quick visual indication of the status of the gaming machine 22. The candle 242 can have any number of configurations and purposes. For example, the candle 242 may be constructed as a clear tube structure containing a variety of staggered color inserts, which when illuminated in predetermined patterns, indicates a status of the gaming machine 22 to a player (e.g., money denomination indicator, jackpot winner indicator) or to casino personnel (e.g., maintenance problem). The candle 242 may also provide a location for additional peripheral devices.

The gaming machine 22 also includes a player control panel 244. The player control panel 244 may be provided with a number of pushbuttons or touch-sensitive areas (i.e., touch screen) that can be pressed by a player to select games, make wagers, make gaming decisions, etc. As used herein, the term “button” is intended to encompass any device that allows a player to make an input, such as a mechanical input device that must be depressed to make an input selection or a display area that a player may simply touch. The number of pushbuttons may include one or more “Bet” buttons for wagering, a “Max Bet” button for making the maximum wager allowable for the game, a “Play” button for beginning pay, a “Repeat” button for repeating the previous wagering selection, a “Collect” button for terminating play and cashing out of the game, a “Help” button for viewing a help screen, a “See Pays” button for causing the video display 231 to generate one or more display screens showing the odds or payout information for the game or games provided by the gaming machine 22, and a “Call Attendant” button for calling an attendant. In addition, if the gaming machine 22 provides a mechanical spinning reel slot game, the player control panel 244 may be provided with a number of wager selection buttons, each of which allows a player to specify a wager amount for each pay line selected. Additional game specific buttons may also be provided on the player control panel 244 or elsewhere on the gaming machine 22 to facilitate play of a specific game executing on the gaming machine 22.

If the gaming machine 22 is configured as a mechanical spinning reel slot game having a number of selectable pay lines which may define winning combinations of reel symbols, the control panel 244 also includes a number of selection buttons. The selection buttons allow the player to select one of a number of possible of pay lines prior to spinning the reels. For example, five selection buttons may be provided to allow a player to select from among one, three, five, seven or nine pay lines prior to each reel spin. Alternatively, a Max Bet button may be provided to allow the player to select a maximum number of pay lines.

As will be understood by those of ordinary skill in the art, the term “control panel” may encompass a plurality or grouping of player activatable buttons. Further, although the control panel 244 is shown to be separate from the video display 231, it should be understood that the control panel 244 could be generated by the video display 231 as a touch-sensitive screen.

Although not separately illustrated, the gaming machine 22 may also include a number of input/output (I/O) ports such as universal asynchronous receiver/transmitter ports to facilitate the addition of auxiliary components such as the ticket printer, the touch screen, the bill validator, etc. Additional I/O ports may also be included on gaming machine 22 to enable progressive jackpot capability, diagnostic capability, jurisdiction system capability, server system capability, etc.

FIG. 3 is a perspective view of another embodiment of one of the gaming machines of FIG. 1 such as the gaming machine 32 having mechanical spinning reels (“adaptable mechanical spinning reel slot machine 32”). The adaptable mechanical spinning reel slot machine 32 includes a plurality of mechanical rotatable reels 302(a), 302(b), 302(c). The adaptable mechanical spinning reel slot machine 32 may also include, among other things, a number of pay lines 310(a), 310(b), 310(c), 310(d), 310(e), a button panel 312, and a number of touch keys 314. Further, in the illustrated example, the spinning reel slot machine 32 is an “upright” version in which the reel display area 304 is oriented vertically relative to the player. Alternatively, the spinning reel slot machine 32 may be a “slant-top” version in which the reel display area 304 is slanted at angle (e.g., thirty degrees) toward the player.

Each of the mechanical rotatable reels 302(a), 302(b), 302(c) includes reel strip affixed to a rotatable reel hub. The reel strip includes a column of reel symbols having both artwork symbols and blank symbols (depicted as blank areas between the artwork symbols). The type and number of symbols may vary between the different the game. For example, each of the reel strips of mechanical rotatable reels 302(a), 302(b), 302(c) may include a column of 11 artwork symbols alternated with 11 blank symbols (collectively referred to herein as “reel symbols”) for one type of slot game, or may each include a column of 9 artwork symbols alternated with 9 blank symbols for another type of slot game. In addition, the mechanical rotatable reels 302(a), 302(b), 302(c) may be mounted to a horizontal axis device to enable vertical spinning, as shown in FIG. 3. Alternatively, the mechanical rotatable reels 302(a), 302(b), 302(c) may be mounted to a vertical axis device to enable horizontal spinning.

The adaptable mechanical spinning reel slot machine 32 may also include an award glass area 306, a belly glass area 308 and a reel display area 304. Each of the award glass area 306, a belly glass area 308 and a reel display area 304 may be configured as a backlit screen panel, painted artwork, an LED display, scrolling artwork, an LCD screen, a video monitor, a vacuum fluorescent display (VFD), etc. If configured using a variable display device such as an LCD, LED, VFD, etc., the award glass area 306, a belly glass area 308 and a reel display area 304 may be used to display video images or LED arrays (collectively referred to as “graphics”) associated with game play. Thus, a first, a second and a third variable display device associated with the reel display area 304, the glass area 306, and the belly glass area 308, respectively, may be included in the adaptable mechanical spinning reel slot machine 32.

The first variable display device may be also be a flat panel transmissive display adapted to superimpose, or overlay, a video graphic 305 upon the mechanically rotatable reels 302(a), 302(b), 302(c) in a reel display area 304. Alternatively, the first variable display device may be a video display or a projector and a partially reflective mirror configured to generate a virtual superimposed video graphic. The superimposed reel glass video graphic 305 may be an instructional information graphic, a pay line graphic, a symbol graphic, a bonus game graphic, a jackpot graphic, a special effects graphic, a game theme graphic, an attract mode graphic, a bonus event graphic and a pay table graphic to name a few. The superimposed reel glass video graphic 305 may also be interactive with the reels to transform blank spaces on the reel(s) (discussed below) into symbols, to superimpose (or overlay) video reel symbols onto the mechanical reel symbols, to highlight winning symbol combinations and to alter mechanical reel symbols. Further, the visual clarity of the superimposed reel glass video graphic 305 may be adjusted by the first variable display device, resulting in an opaque, a translucent, or a transparent video image. A reel spinning slot machine with superimposed video images or graphics generated via a variable display device is described in U.S. Pat. No. 6,517,433, entitled “Reel Spinning Slot Machine with Superimposed Video Image,” naming Loose et al. as inventors, filed May 22, 2001 (“the Loose et al. patent”), and herein incorporated by reference in its entirety.

The second variable display device, operable as described in the Loose et al. patent, may be adapted to provide images such as pay table video images, graphics to an award glass area 306, live video feed, such as concerts, sporting events, plays, or a comedy stage, or recorded video. The third variable display device, operable as described in the Loose et al. patent, may be adapted to provide a plurality of game theme video images or graphics to a belly glass display area 308. Additionally, a touch screen may be provided in conjunction with any of the first, second, or third variable displays to enable a player to select game options such as a game denomination or a game theme (if multi-game capability is provided on the adaptable spinning reel slot machine 32). Although the first, second and third variable display devices are preferably configured using flat panel flat transmissive displays available from LG Phillips Co., Ltd, of Seoul Korea, they may be configured using organic light-emitting diode displays available from Eastman Kodak Company. They may also be configured using a CRT, an LCD, an LED array, an electro-luminescent or any other type of variable display known in the art. In addition, any of the first, second, or third variable display devices may also display advertisements, for example, an advertisement for a casino buffet, or may display images of players, etc.

In addition to selection by the adaptable spinning reel slot machine 32, the images or graphics displayed on the first, second, or third variable display may be selected by a coupled server such as the server 20, 30, or by another gaming machine (a “peer gaming machine”) if a peer-to-peer configuration is implemented in the server-based gaming system 10. Further, the images may be selected based on a number of factors including a time of day, a day of a week, a promotional activity, a local activity, an identity of the player, a selection made by player, a selection made by a casino operator, etc.

The adaptable spinning reel slot machine 32 may also include a front lighting apparatus and/or a backlighting apparatus. The front lighting apparatus is preferably an array of colored LEDs positioned in front of the mechanical reels, however, other suitable front lighting apparatus are contemplated. If a blacklight sensitive ink is used for the reel symbols, the front lighting apparatus may also include one or more blacklights to enhance or change the reel symbols. The backlighting apparatus is preferably a lamp array positioned behind the reel strips affixed to the rotatable reel hub, however, other suitable backlighting apparatus are contemplated. In response to a communication (e.g., a communication from a coupled server 20, 30, a communication from a coupled gaming machine, from a player input, etc.) to change or modify a game, the mechanical reel symbols or symbol colors can be modified via the front lighting or backlighting apparatus. For example, the mechanical reel symbol colors of the adaptable spinning reel slot machine 32 can be changed by the coupled server 20 via the front lighting and backlighting apparatus individually or can be changed in tandem with new color combinations displayed in the award glass area 306.

Although not separately illustrated in FIG. 3, the adaptable spinning reel slot machine 32 may also include one of any number of motor driven game elements such as dice, a wheel, flip cards, etc. In that case, a fourth variable display device can be configured to provide video graphics to the area of the electro-mechanical device. Alternatively, one of the first, second or third variable display devices may also be configured to provide graphics to the area of the electro-mechanical device.

As previously mentioned in connection with FIG. 1, feature options may reside within the gaming machines 22, 32 or may reside within coupled servers 20, 30. The feature options may also reside within a coupled peer gaming machine if a peer-to-peer gaming machine configuration is implemented. Such feature options may be used to control operation and/or the appearance of the gaming machines 22, 32 by providing hold percentage configurations, game play denomination configurations, minimum wager amount configurations, top award configurations, bonus game scheme configurations, player specific bonus feature configurations, mechanical device motion profiles, electronic transfer fund configurations, game theme configurations, lighting configurations, sound configurations, harm minimization behavior configurations, casino float configurations, etc.

The feature options, via a variable display device, may also be used to further control the appearance of the gaming machines 22, 32. For example, if one or more variable display devices are included in the adaptable spinning reel slot machine 32, the feature options may also include graphics configurations, attract mode configurations, advertising configurations, game graphic configurations etc., and therefore provide instructional information graphics, pay line graphics, symbol graphics, pay table graphics, bonus game graphics, jackpot graphics, special effect graphics, game theme graphics, attract mode graphics, advertising graphics, etc.

If resident on the adaptable spinning reel slot machine 32, selection of one or more of the feature options may be accomplished by the adaptable spinning reel slot machine 32, by a coupled server 20, 30 or by a coupled peer gaming machine. If not resident within the adaptable spinning reel slot machine 32, the feature options may be downloaded from a coupled server 20, 30, from a coupled peer gaming machine, from a high capacity storage device or from a handheld device. In that case, selection of the feature options may be also be accomplished by the adaptable spinning reel slot machine 32, by a coupled server 20, 30 or by a peer gaming machine. In addition, the feature options may be downloaded and/or configured based on an occurrence of an event such as a time of day, a day of the week, a promotional activity, a local activity, an identity of a player, a selection made by the player, a selection made by a casino operator, etc. As a result, a change to the operation and/or appearance of the adaptable spinning reel slot machine 32 may occur with or without manual intervention by a casino operator. Additional details concerning the selection and/or configuration of feature options are found in commonly assigned U.S. patent application Ser. No. 10/375,855, filed Feb. 26, 2003, entitled “Configuration of Gaming Machines,” the entirety of which is incorporated by reference herein.

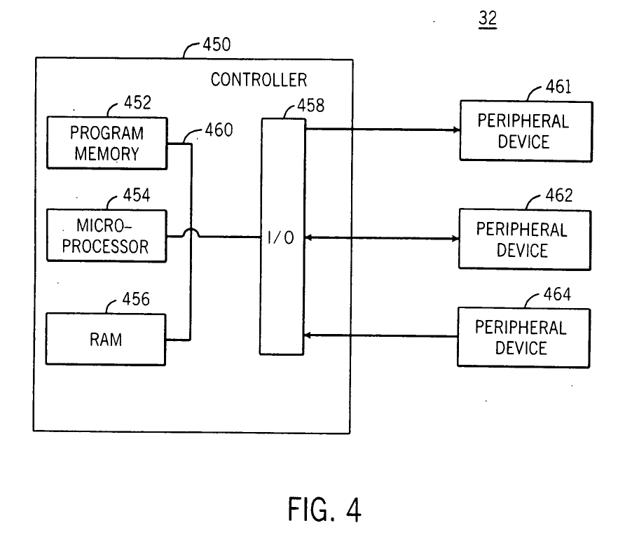

FIG. 4 is a block diagram of a number of components that may be incorporated in the gaming machines 22, 32 of FIG. 1. Referring to FIG. 4, each of the gaming machines 22, 32 includes a controller 450 (“gaming machine controller”) that may comprise a program memory 452 (including a read-only memory (ROM)), a microcontroller-based platform or microprocessor (MP) 454, a random-access memory (RAM) 456 and an input/output (I/O) circuit 458, all of which may be interconnected via a communications link, or an address/data bus 460. The microprocessor 454 is capable of displaying images, symbols and other indicia such as characters, people, places, things, and faces of cards. The RAM 456 is capable of storing event data or other data used or generated during a particular game. The program memory 452 is capable of storing program code, which controls the gaming machines 22, 32 so that it plays a particular game in accordance with applicable math models, game rules, and pay tables.

It should be appreciated that although only one microprocessor 454 is shown, the controller 450 may include multiple microprocessors 454. For example, if in the gaming machine 22, 32, the controller 450 may include one microprocessor for low level gaming functions and another processor for higher level game functions such as some communications, security, maintenance, etc. Similarly, the memory of the controller 450 may include multiple RAMs 456 and multiple program memories 452, depending on the requirements of the gaming machines 22, 32. Although the I/O circuit 458 is shown as a single block, it should be appreciated that the I/O circuit 458 may include a number of different types of I/O circuits. The RAM(s) 456 and program memory(s) 452 may be implemented as semiconductor memories, magnetically readable memories, and/or optically readable memories, etc. Further, the term “controller” or “computer” are used herein to refer collectively to the program memory 452, the microprocessor 454, the RAM 456 and the I/O circuit 458.

FIG. 4 illustrates that multiple peripheral devices depicted as peripheral devices 461, 462, and 464 may be operatively coupled to the I/O circuit 458. Each of the peripheral devices 461, 462, 464 is coupled to the I/O circuit 458 by either a unidirectional or bidirectional, single-line or multiple-line data link, depending on the design of the component that is used. Although three peripheral devices are depicted, more or less peripheral devices may be included in FIG. 4.

The peripheral devices of the gaming machines 22, 32 may include one or more of a control panel with buttons, a coin acceptor, a note acceptor, a bill validator, a card reader, a number of mechanical spinning reels, a keypad, a sound circuit driving speakers, a card reader display, a video display, etc., operatively coupled to the I/O circuit 458, either by a unidirectional or bidirectional, single-line or multiple-line data link or wireless link, depending on the design of the component that is used. In addition, a touch screen controller (not separately illustrated) may be included when a touch screen is utilized to allow a player to input decisions into the gaming machines 22, 32 via sending discrete signals based on the area of the touch screen provided on the gaming machines 22, 32, that the player touches or presses.

It should be appreciated that although the controller 450 is a preferable implementation of the present invention, the present invention also contemplates being implemented via one or more application specific integrated circuits (ASICs), field programmable gate arrays (FPGA), adaptable computing integrated circuits, one or more hardwired devices, or one or more mechanical devices. Furthermore, although the controller 450 preferably resides in each of the gaming machines 22, 32, the present invention contemplates providing some or all of its functions at another location for communication to the gaming machines 22, 32 via the communication network 14.

One manner in which one or more of the gaming machines 22, 32 of the server-based gaming system 10 may operate is described below in connection with a number of flowcharts which represent a number of portions or routines of one or more computer programs, which may be stored in one or more of the memories of the controller 450. The computer program(s) or portions thereof may also be stored remotely, outside of the gaming machines 22, 32 and may therefore control the operation from a remote location. Such remote control may be facilitated via a wire line or wireless connection, or by an Internet or Intranet interface that connects the gaming machines 22, 32 and/or the servers 20, 30 with a remote computer having a memory in which the computer program portions are stored.

Although not separately illustrated, a controller 480 (“coupled apparatus controller”) substantially configured and operable as described above in connection with the controller 450, is included in the servers 20, 30. The peripheral devices associated with the controller 480 may therefore include a keyboard, a graphical interface unit (GUI) display, a number of communication ports, a monitor, a printer, a modem, a keyboard, a tape drive, a DVD drive, a CD drive, etc.

Referring again to FIG. 3, in response to a wager, each of the mechanical rotatable reels 302(a), 302(b), 302(c) are rotated and then stopped. As described above, selection of the amount wagered and the number of pay line(s), and the method of activating the reel spin (e.g., depressing a Max Bet Spin button or a Spin Reels button, pulling a lever) may vary depending on the game provided and the player's preference. For a centrally determined outcome, the controller 480 (of the coupled server 20, 30) determines the game outcome. The reel positions for each of the mechanical rotatable reels 302(a), 302(b), 302(c) however, may be determined by the controller 480 or the controller 450 (of the adaptable mechanical spinning reel slot machine 32). For a locally determined outcome, the game outcome is determined by the controller 450 however, the reel positions may be determined either by the controller 450 or the controller 480. In addition, the controller 480 of the coupled server 20, 30 may provide enhancements such as community progressive games, community bonus games, tournaments, etc. to the adaptable mechanical spinning reel slot machine. As is known in the art, variations of “pooled” math or RNG math may be used by the adaptable mechanical spinning reel slot machine 32 or coupled servers 20, 30 as a basis for the game outcome or the “value payout.”

If the value payout indicates an award, a winning symbol combination is displayed to the player via the reel symbols (i.e., artwork or blank symbols) and/or reel symbol images provided by a variable display device. The winning symbol combination occurs when the reel symbols (both fixed and superimposed, if provided) appearing on reels 302(a), 302(b), 302(c) along a selected pay line correspond to one of the winning symbol combinations displayed on a pay table, typically in the award glass area 306. The winning symbol combination could be, for example, two matching double bar artwork symbols and a wild card symbol image superimposed on a blank symbol.

Traditional mechanical spinning reel slot machines are typically limited to a single themed slot game due to (1) the use of EPROMs or their equivalent providing game aspects such as game software, hold percentages, game denominations, minimum wager amounts, top awards and associated symbol configurations, bonus award schemes, and sound configurations, and due to (2) the use of fixed configuration reel strips, (3) the use of fixed configuration pay table glass and (4) the use of fixed configuration belly glass. As a result, traditional mechanical spinning reel slot machines require manual replacement of parts such as the EPROM(s), reels, the belly glass, etc., in order to change the operation and/or appearance of the traditional mechanical spinning reel slot machine.

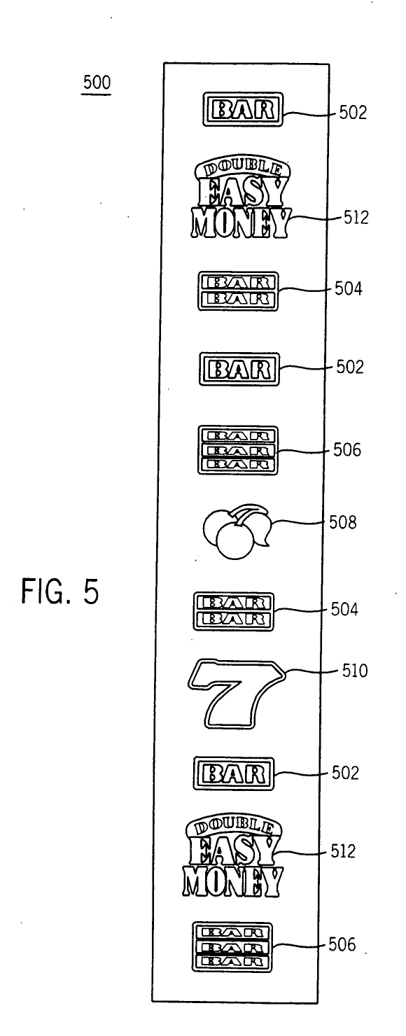

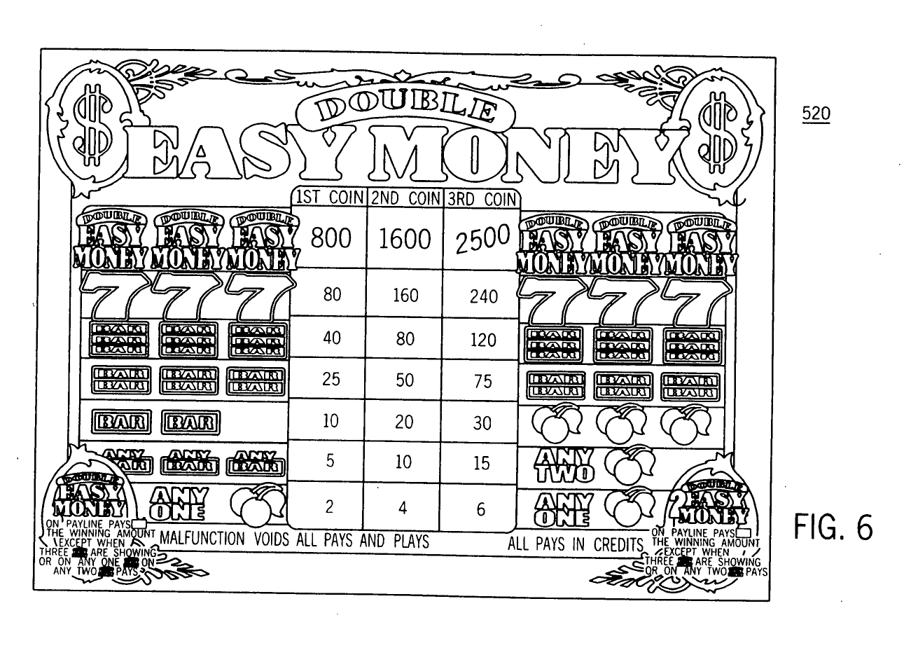

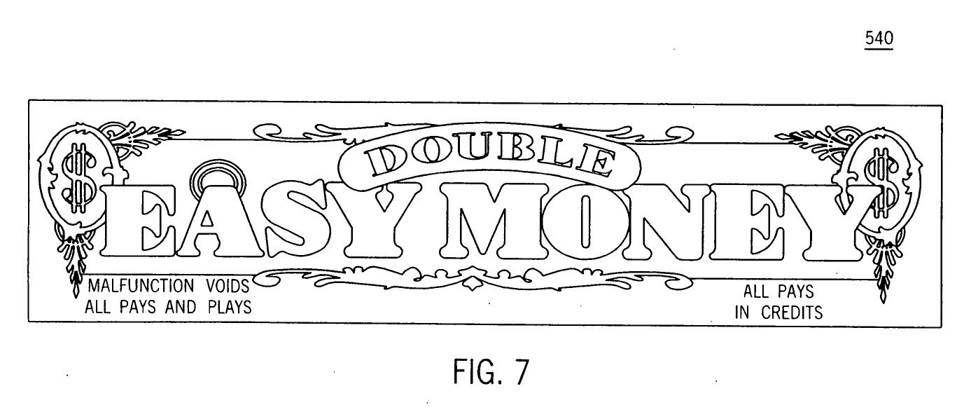

For example, referring to FIGS. 5, 6, and 7, a mechanical spinning reel slot machine having three spinning reels may be configured to play a slot game such as Double Easy Money™. FIG. 5 is an exemplary fixed configuration reel strip 500 affixed to the reel hubs of a mechanical spinning reel slot machine. As illustrated by FIG. 5, each reel strips 500 has a fixed configuration of 11 artwork symbols and 11 blank symbols (i.e., 22 reel stops). The 11 artwork symbols include three single bar symbols 502, two double bar symbols 504, two triple bar symbols 506, a cherry symbol 508, a number “7” symbol 510 and two themed symbols 512 (e.g., “Double Easy Money”). FIG. 6 is an exemplary pay table glass display 520 of mechanical spinning reel slot machine. As illustrated by FIG. 6, the pay table glass display 520 of the mechanical spinning reel slot machine offering Double Easy Money™ includes a fixed configuration display showing nine winning symbol combinations plus doubling winning symbol combinations and their associated value payouts. Similarly, as illustrated by FIG. 7, a belly glass display 540 of the mechanical spinning reel slot machine offering Double Easy Money™ includes a fixed configuration theme display. [076] Changing or modifying a mechanical spinning reel slot machine such as the mechanical spinning reel slot machine offering Double Easy Money™ as discussed above, would therefore require manual replacement of the reel strips, the pay table glass and/or the belly glass. As a result, benefits typically associated with the use of coupled servers in a server-based gaming network, for example, downloading approved gaming software from a coupled server or a peer gaming machine to another gaming machine, automated control of video images that may be presented on the gaming machines, central determination of game outcome, etc., have been associated only with gaming machines offering video based games, and not with traditional mechanical spinning reel slot machines. In addition, the benefits associated with automatic downloading of hold percentage configurations, game play denomination configurations, minimum wager amount configurations, top award configurations, bonus game scheme configurations, player specific bonus feature configurations, mechanical device motion profiles, electronic transfer fund configurations, game theme configurations, lighting configurations, sound configurations, harm minimization behavior configurations, casino float configurations, graphics configurations, attract mode configurations, advertising graphics, and game graphic configurations have been associated only with gaming machines offering video based games, and not with mechanical spinning reel slot machines.

Operation of the Adaptable Electro-Mechanical Machine in the Networked Gaming Environment

Unlike the traditional mechanical spinning reel slot machine, the adaptable mechanical spinning reel slot machine 32 is configured to be responsive, not only to its controller 450, but also to the controller 480 (of the server 20, 30) and/or to other gaming machine(s) if a peer-to-peer configuration is implemented in the server-based gaming network 10.

In one embodiment, operation of the adaptable mechanical spinning reel slot machine 32 may be substantially controlled by a coupled server 20, 30. In that case, the coupled server 20, 30 detects a wager to play the slot game, determines the value payout of the slot game and causes the symbol-bearing reels to rotate and stop to place the symbols in a symbol array yielding the value payout. If the value payout indicates an award to the player, a winning symbol combination associated with the award is included in the symbol array and the server 20, 30 causes an award equivalent to the value payout, generally credits, to be dispensed or otherwise provided to the player. In addition, if provided on the adaptable mechanical spinning reel slot machine 32, one or more variable display device(s) may display graphics before, during, and after slot game play, where the graphics are selected by the coupled server 20, 30. The graphics may include instructional, information graphics, pay line graphics, symbol graphics, bonus game graphics, jackpot graphics, special effects graphics, game theme graphics, attract mode graphics, bonus event graphics, pay table graphics, etc.

In another embodiment, operation of the adaptable mechanical spinning reel slot machine 32 may be partially controlled by a coupled server 20, 30. In that case, the adaptable mechanical spinning reel slot machine 32 receives a wager to play the slot game. In response to the wager received by the adaptable mechanical spinning reel slot machine 32, the coupled server 20, 30 determines a value payout of the slot game. Based on the value payout determined by the coupled server 20, 30, the adaptable mechanical spinning reel slot machine 32 causes the symbol-bearing reels to rotate and stop to place the symbols in a symbol array. The symbol array is selected by the adaptable mechanical spinning reel slot machine 32 from among a plurality of symbol arrays yielding the server-determined value payout. If the value payout indicates an award to the player, a winning symbol combination associated with the award is included in the symbol array and an award equivalent to the value payout, generally credits, is dispensed or otherwise provided to the player. In addition, if provided on the adaptable mechanical spinning reel slot machine 32, one or more variable display device(s) may display graphics before, during, and after slot game play, where the graphics are selected by the coupled server 20, 30, or selected by the adaptable mechanical spinning reel slot machine 32 (if previously downloaded by the coupled server 20, 30 or if resident).

In yet another embodiment, a configuration of the adaptable mechanical spinning reel slot machine 32 may be controlled by the adaptable mechanical spinning reel slot machine 32 based on selected feature options previously downloaded from a coupled server 20, 30, a coupled peer gaming machine, a handheld device or a high capacity memory device. The feature options determine one or more game aspects of the adaptable mechanical spinning reel slot machine 32 and may therefore include hold percentage configurations, game play denomination configurations, minimum wager amount configurations, top award configurations, bonus game scheme configurations, player specific bonus feature configurations, mechanical device motion profiles, electronic transfer fund configurations, game theme configurations, lighting configurations, sound configurations, harm minimization behavior configurations, casino float configurations, graphics configurations, attract mode configurations, advertising graphics, and game graphic configurations. In addition, feature options such as hold percentage configurations, game play denomination configurations, minimum wager amount configurations, top award configurations, bonus game scheme configurations, player specific bonus feature configurations, mechanical device motion profiles, game theme configurations, lighting configurations, sound configurations, harm minimization behavior configurations, casino float configurations (e.g., coins in a coin hopper of the adaptable mechanical spinning reel slot machine 32), graphics configurations, attract mode configurations, advertising graphics, game graphic configurations, etc. The feature options may also include electronic funds transfer (EFT) capability and player specific bonus features which allow a player to, for example, “store” specific reel symbols (e.g., a special 7) in an identifiable account for later game play. The money for the electronic funds may be entered via the adaptable mechanical spinning reel slot machine 32, a coupled server 20, 30, a peer gaming machine or any suitably configured device. In the case where the adaptable mechanical spinning reel slot machine 32 controls its configuration, it may select one or more of the feature options from among the available feature options. Selection of the feature options may be based on one of any number of triggering events such as a time of day, a day of the week, a promotional activity, a local activity, a player identity and associated preferences, a player selection (e.g., selecting a particular themed slot game from among a number of themed slot games), a casino operator selection, etc. For example, if a gaming proprietor wishes to change a hold percentage, a game play denomination and a minimum wager amount during a certain period of the day, for example, during a “Happy Hour” period, the controller 450 causes the appropriate feature options to be selected, thereby configuring and reconfiguring the adaptable mechanical spinning reel slot machine 32 with or without daily manual intervention by a casino operator.

Upon receiving a wager to play the slot game, the adaptable mechanical spinning reel slot machine 32 determines a value payout of the slot game. Based on the value payout, the adaptable mechanical spinning reel slot machine 32 causes the symbol-bearing reels to rotate and stop to place the symbols in a symbol array. Thus, both the value payout and the associated symbol array are selected by the adaptable mechanical spinning reel slot machine 32 previously configured using the feature options. If the value payout indicates an award to the player, a winning symbol combination associated with the award is included in the symbol array and an award equivalent to the value payout is dispensed or otherwise provided to the player. In addition, if provided on the adaptable mechanical spinning reel slot machine 32, one or more variable display device(s) may display graphics before, during, and after slot game play, where the graphics are selected by the coupled server 20, 30, or selected by the adaptable mechanical spinning reel slot machine 32 (if previously downloaded by the coupled server 20, 30).

In a further embodiment, a configuration of the adaptable mechanical spinning reel slot machine 32 may be controlled by the coupled server 20, 30 or a peer gaming machine, based on one or more features options selected by the coupled server 20, 30 or peer gaming machine(s). The feature options are selected from among a plurality of feature options which may be stored in a memory device of the adaptable mechanical spinning reel slot machine 32 or may be downloaded from a suitably configured server or peer gaming machine. Selection of the feature options may be based on one of any number of triggering events as discussed above.

Upon receiving a wager to play the slot game, the adaptable mechanical spinning reel slot machine 32 determines a value payout of the slot game. Based on the value payout, the adaptable mechanical spinning reel slot machine 32 causes the symbol-bearing reels to rotate and stop to place the symbols in a symbol array. Thus, both the value payout and associated symbol array are selected by the adaptable mechanical spinning reel slot machine 32 where the adaptable mechanical spinning reel slot machine 32 was previously configured using the feature options selected by the coupled server 20, 30 or by a coupled peer gaming machine. If the value payout indicates an award to the player, a winning symbol combination associated with the award is included in the symbol array an award equivalent to the value payout is dispensed or otherwise provided to the player. In addition, if provided on the adaptable mechanical spinning reel slot machine 32, one or more variable display device(s) may display graphics before, during, and after slot game play, where the graphics are selected by the coupled server 20, 30, a coupled peer gaming machine or the adaptable mechanical spinning reel slot machine 32 (if previously downloaded by the coupled server 20, 30).

Unlike a traditional spinning reel slot machine, a number of variable display devices may be provided on the adaptable mechanical spinning reel slot machine. Thus, if provided in the adaptable mechanical spinning reel slot machine 32, a first, a second, a third variable display device, etc. may be adapted to be responsive to the controller 450, the controller 480 (i.e., server controller) and/or to another controller of the server-based gaming network 10. As a result, reel glass graphics provided by the first variable display device to the reel display area 304, pay table graphics provided by the second variable display device to the award glass area 306, and game theme graphics provided by the third variable display device to the belly glass display area 308 may be selected or changed with or without manual operator intervention. Further, audio and lighting of the adaptable mechanical spinning reel slot machine 32 may be selected or changed with or without manual operator intervention. As a result, the adaptable mechanical spinning reel slot machine 32 can obtain the visual benefits typically associated with gaming machines offering video games in a server-based gaming network.

For example, referring to the embodiments described above, a coupled server 20, 30 may select and download feature options to the adaptable mechanical spinning reel slot machine 32 that alter the return-to-player percentage (or the hold percentage for the gaming proprietor), the slot game play denomination and the minimum wager amount. As a result, a change to the images provided by one or more of the variable display devices (if provided) of the adaptable mechanical spinning reel slot machine 32 may be required. Thus, images displayed in the reel display area 304, the award glass area 306, and/or the belly glass display area 308 may require modification or updating to reflect the selected feature options.

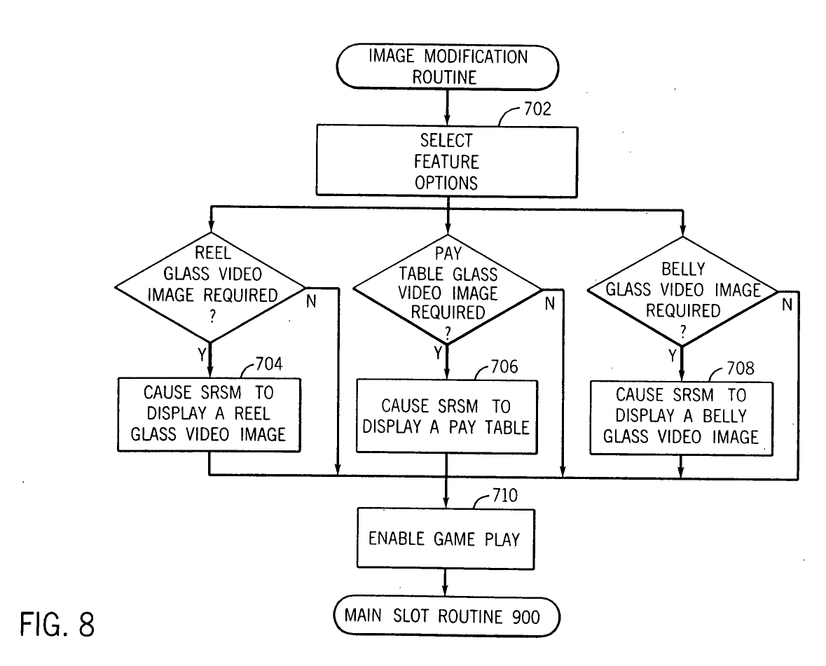

FIG. 8 is a flowchart of an image modification routine 700 that may be performed by the coupled servers 20, 30 of FIG. 1. The image modification routine 700 may be stored in one or more of the memories of the controller 480 or it may be stored remotely in another controller memory (e.g., the controller 450). The image modification routine 700 illustrates one example of image modification to images or graphics provided by the variable display devices of the adaptable mechanical spinning reel slot machine 32 in response to selection of feature options.

Referring to FIG. 8, the image modification routine 700 begins operation when feature options either previously downloaded or stored in a memory device of the adaptable mechanical spinning reel slot machine 32 are selected (step 702). The feature options may be selected to encourage game play during a traditionally slow period of the day, for example. Upon selection of the feature options, the controller 480 causes the spinning reel slot machine 32 to display the appropriate visual images and sounds associated with the selected feature options. For instance, a new pay table image corresponding to the selected feature options may be required to reflect the increased return-to-player percentage. In that case, the controller 480 may cause a new pay table image to be displayed (step 704) in the award glass area 306. In addition, a new reel glass image (step 706) may also be displayed in the reel display area 304. The new reel glass image may be used to visually enhance a fixed artwork reel symbol. For example, a new border associated with a “Happy Hour” period may be superimposed on the borders of the single, double and triple bars to indicate to the player that a jackpot has been temporarily doubled. Similarly, the controller 480 may cause a new belly glass image (step 706) to be displayed in the belly glass display area 308 in response to the feature option selection. In addition, a new front lighting scheme, back lighting scheme and/or blacklighting scheme may be displayed in conjunction with the new reel glass image, the pay table image and/or the game theme image to reflect the feature option selection. Other feature options that may be selected include pay table weighting or highlighting intermediate pays.

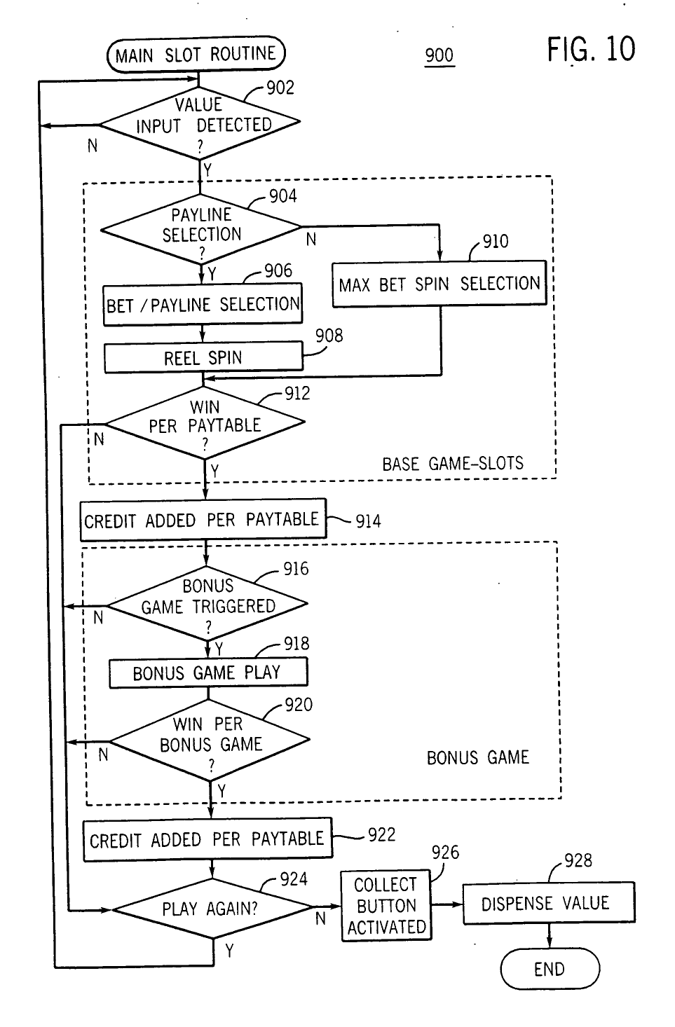

Next, game play of the adaptable mechanical spinning reel slot machine 32 is enabled. During game play, further adjustments to the reel glass image(s) and the pay table image(s) may occur, depending on the selected feature options. A main slot routine 900 discussed in connection with FIG. 10 illustrates the steps of an exemplary slot routine where the outcome may be based on the selected feature options.

Selection of the feature options may be initiated in one of any number of ways, depending on the configuration of the adaptable mechanical spinning reel slot machine 32 and the coupled servers 20, 30. For example, feature options may be selected in response to a time of day, day of the week, a promotional scheme, a player identity, a player selection, or a gaming proprietor selection.

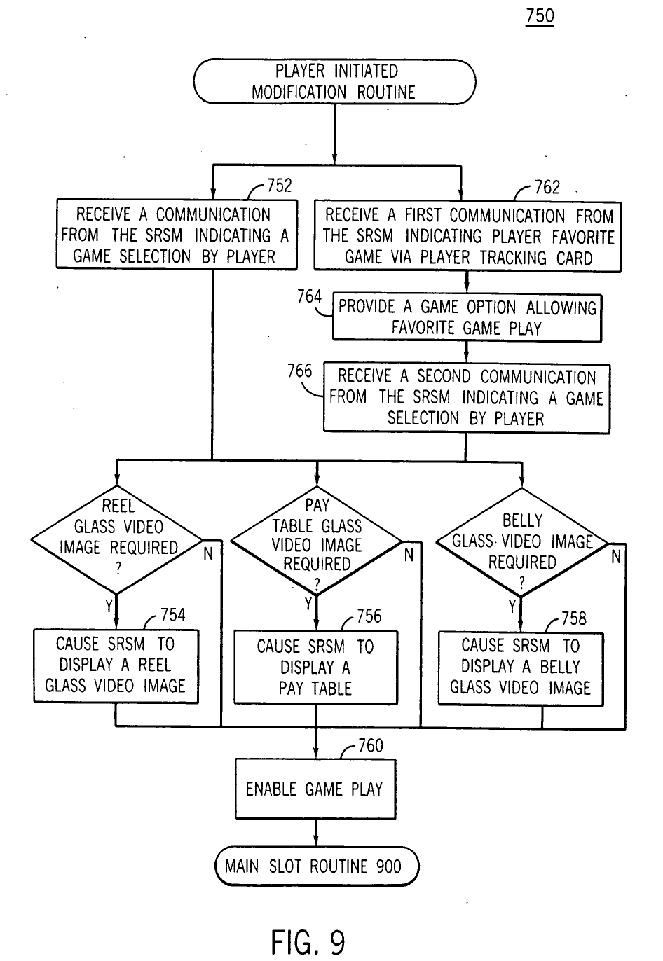

FIG. 9 is a flowchart of a player-initiated modification routine 750, initiated by a player or a player's identity, which may be performed by the coupled servers 20, 30 of FIG. 1. The player-initiated modification routine 750 may be stored in one or more of the memories of the controller 480 or other memory device of the coupled servers 20, 30 or may be stored remotely in another controller memory (e.g., a peer gaming machine memory). The player-initiated modification routine 750 is another example of the coupled server 20 providing modifications to reel glass images, game theme images, and pay table images of the spinning reel slot machine 32 in response to feature option selections.

Referring to FIG. 9, the player-initiated modification routine 750 begins operation when a player selects a game from among a number of games (i.e., a mechanical multi-game spinning reel slot machine) offered by of the spinning reel slot machine 32. The game choices provided by the mechanical multi-game spinning reel slot machine may result from previous feature options selected by the coupled server 20, 30 in response to a promotional scheme, for example. The game choices may be displayed in any one of a number of locations on the spinning reel slot machine 32 (e.g., the reel display area) and may be selectable via a pushbutton or a touch-sensitive button provided as a touch screen by the video display device(s).

Mechanical multi-game spinning reel slot machine providing different game themes, sound and glass configurations, etc. may utilize some similar or identical artwork reel symbols, or “generic” symbols (i.e., a single bar, a double bar, a triple bar, a cherry, a number “7”) for each of the different games. Non-similar or non-identical artwork reel symbols associated with a particular game theme can then be displayed as one or more video images, either resident on a display device of, or downloaded to, the adaptable mechanical spinning reel slot machine 32 during game play. As mentioned above, the video images may be downloaded from the server 20, 30, a coupled peer gaming machine or from another suitable machine having a processor and a memory. In addition, visual alterations to any of the reel symbols may also be accomplished using video images provided by a variable display device of the mechanical multi-game spinning reel slot machine.

For example, referring again to FIG. 5, if Double Easy Money™ is selected by the player, the Double Easy Money theme reel symbol 512 may be provided as a video image superimposed on a blank symbol of a reel while the remaining generic artwork symbols (i.e., the single bar 502, the double bar 504, the triple bar 506, the cherry 508, and the number “7” 510) may be provided via the reel strip.

Upon selection of a game by the player, the coupled server 20 may receive a communication (step 752) from the adaptable mechanical spinning reel slot machine 32. The communication indicates the game selection by the player. In response to the communication, the controller 480 causes the appropriate visual images and sound associated with the selected game to be displayed on the adaptable mechanical spinning reel slot machine 32. For instance, if required for game play, the controller 480 of the coupled server 20 may cause the adaptable mechanical spinning reel slot machine 32 to display a reel glass image (step 754), to display a pay table image (step 756) and/or to display a game theme image (step 758). In addition or alternatively, the controller 480 may cause a particular front lighting scheme, back lighting scheme and/or blacklighting scheme to be displayed in conjunction with, or apart from, the reel glass image, the pay table image and the game theme image.

The controller 480 may cause the adaptable mechanical spinning reel slot machine 32 to display the appropriate visual images associated with the selected game in any one of a number of ways, depending on the configuration of the spinning reel slot machine 32. If the visual images were previously downloaded to the adaptable mechanical spinning reel slot machine 32, the controller 480 sends a communication to the adaptable mechanical spinning reel slot machine 32, indicating that the visual images are to be displayed. Alternatively, if the visual images were not previously downloaded to the spinning reel slot machine 32, the controller 480 may download the visual images directly to the reel display area 304, the award glass area 306 and/or the belly glass display area 308.

For example, if the player selects the Double Easy Money™ game from among other offered games, the controller of the coupled server 20 may cause the adaptable mechanical spinning reel, slot machine 32 to display a reel glass video image on the reel display area 304 as described above, a pay table video image (see FIG. 6) in the award glass area 306 and a game theme video image (see FIG. 7) in the belly glass display area 308 associated with the Double Easy Money™ game.

Next, game play of the adaptable mechanical spinning reel slot machine 32 is enabled (step 760). Players of the spinning reel slot machine 32 can then play a slot game where game aspects such as minimum denomination, return-to-player percentages, etc., may be based on the selected feature options. During game play, further adjustments to the reel glass image(s) and the pay table image(s) may occur, depending on the selected feature options. A main slot routine 900 discussed in connection with FIG. 10 illustrates the steps of an exemplary slot routine where game aspects are determined by selected feature options. Upon completion of the game, the player may elect to play a second type of slot game requiring a different reel glass image, pay table image and game theme image.

Therefore, as mentioned above, selection of feature options may be initiated based on player identity data transmitted from the adaptable mechanical spinning reel slot machine 32 to the coupled server 20. For example, in response to receipt of a communication including player identity data from the adaptable mechanical spinning reel slot machine 32 (step 762), the controller 480 using selected feature options may reconfigure the mechanical spinning reel slot machine 32, allowing the player to select (step 764) their favorite game from among multiple games. The player identity data is received by the coupled server 20, 30 when the player inserts a player tracking card or other appropriate card into a suitable location of the adaptable mechanical spinning reel slot machine 32. Upon selection of a game by the player, the coupled server 20 may receive another communication (step 766) indicating a game selection by the player from the adaptable mechanical spinning reel slot machine 32. Then, in response to the communication, the controller 480 may cause the adaptable mechanical spinning reel slot machine 32 to display the appropriate visual images, sound denominations, etc. associated with the selected game as discussed above.

For example, player tracking card data may indicate that the player's favorite game is Double Easy Money™. In response to receipt of the communication indicating player identity, the controller 480 may add, via a touch screen selectable button provided on the reel display area 304, a game option allowing the player to select the Double Easy Money™ game from among other games. Then, in response to another communication indicating election of the Double Easy Money™ game, the controller 480 may cause the adaptable mechanical spinning reel slot machine 32 to display the visual images and provide the sounds associated with the Double Easy Money™ game as discussed above. Likewise, the controller 480 may also provide a game option allowing the player to select from among games similar to the Double Easy Money™ game such as Double Double Easy Money™.

Selection of particular feature options may also be initiated based on the time of day. For example, in order to promote game play during a traditionally slow period of the day, the controller 480 may select feature options resulting in a change to the pay table image to reflect higher value payouts to the players during a predetermined time period such as the time period between the hours of 2:00 pm to 5:00 pm (e.g., happy hour). At the end of the predetermined time period (5:00 pm) the controllers 480 may restore the value payouts and the pay table image to their previous configuration reflecting the lower payouts.

In another example, current data gathered by the controller 480 from the adaptable mechanical spinning reel slot machine 32 and as well as other gaming machines, may indicate that some games are more popular than others. Based on that data, the controller 480 can then replace less popular or idle games via feature option selection with the more popular games with or without manual intervention at the adaptable mechanical spinning reel slot machine 32.

Although the image modification routine 700 and the player-initiated modification routine 750 are illustrated using an adaptable mechanical spinning reel slot machine having a variable reel display area, a variable award glass area, and a variable game theme display area adapted to variable images, it should be understood that other configurations of the adaptable mechanical spinning reel slot machine may be utilized in accordance with the present invention. For example, an adaptable mechanical spinning reel slot machine utilizing fixed images (such as those provided by silk-screened glass) in the award glass area and the game theme display area may be utilized in accordance with the present invention. In addition, other types of electro-mechanical gaming machines with electro-mechanical components (e.g., dice, wheels, and other motor driven game elements) may be utilized in accordance with the present invention.

Slot Game

FIG. 10 is a flowchart of an embodiment of the slot routine 900 that may be performed by the adaptable mechanical spinning reel slot machine 32 having, three mechanical spinning reels. The slot routine 900 may be stored in one or more,of the memory devices of the adaptable mechanical spinning reel slot machine 32, or it may be stored remotely outside of the mechanical spinning reel slot machine 32, for example, in the controller 480.

Referring to FIG. 10, the slot routine 900 may begin operation when the,controller 480 or (the controller 450) detects a game selection by a game player or detects a value input from the game player (step 902). The controller detects the value input if the player deposited one or more coins, paper currency, a card, or a voucher into the adaptable mechanical spinning reel slot machine 32. Upon detection of the game selection or the value input, the controller enables a base game to be played. In the illustrated example, the base game comprises a slot game. However, the base game may also comprise any number of other casino games adapted to be played on the adaptable mechanical spinning reel slot machine 32 or other electro-mechanical gaming machines.

After value input detection, the controller enables a pay line selection (step 904). If there is only one pay line, the controller enables play of the base game (step 908). If there is more than one pay line, the controller enables a bet-per-pay line selection (step 906) as follows. First, the player may either depress a button such as a “Select Lines” pushbutton provided on a player the button panel 312 of the adaptable mechanical spinning reel slot machine 32 to make a pay line selection, or depress a video display button if provided by a touch screen on the adaptable mechanical spinning reel slot machine 32. As mentioned above, the touch screen may be provided by a variable display device of adaptable mechanical spinning reel slot machine 32. The pay line selection causes one or more pay lines to be activated.

Second, the player may either depress a button such as a “Bet Per Line” pushbutton provided on the button panel 312 to make a bet-per-pay line selection, or depress a video display button if provided by a touch screen on the gaming machine 32. The bet-per-pay line selection causes an amount per pay line to be wagered with the total wager divided equally between each selected pay line if multiple pay lines are selected. The bet-per-pay line is typically displayed to the player via a bet meter on the adaptable mechanical spinning reel slot machine 32. In addition, the controller may enable the player to select a maximum bet (via a “Max Bet Spin” button). Thus, the player may chose maximum bet option causing maximum pay line selection and maximum credits (step 910) rather than the pay line selection (step 904) and the bet per pay line selection (step 906).

After detecting the pay line(s) and bet-per-pay line selections (if applicable) and verifying the value input, the controller enables the reel spin (step 908) and determines a game outcome or value payout. The player may spin the reels of the gaming machine 32 by depressing a button such as a “Spin Reels” pushbutton provided on the button panel 312. Alternatively, the player may pull a handle provided on the adaptable mechanical spinning reel slot machine 32 to initiate the reel spin. In either case, the controller stops the reels to display a symbol array reflecting the determined value payout. As previously mentioned, the symbol array may include the artwork and blank reel symbols of the three mechanical spinning reels or a combination of the artwork and blank reel symbols and video reel symbol images superimposed on the mechanical spinning reels (if a variable display device is provided).

A pay table, typically displayed on the award glass area, shows the winning combinations of reel symbols and the associated awards. If the value payout indicates an award to the player, a winning symbol combination associated with the award is included in the symbol array and the award is credited to the player. The award is typically reflected as credits on a credit meter of the adaptable mechanical spinning reel slot machine 32. If the controller determines that the player has not won, additional slot game play is enabled for the player. The controller also enables a cash-out option (step 926) via a cash-out button, for example, a “Collect” button provided on the gaming machine 32 if the player does not desire further game play (step 924). Upon selection of the cash-out button, the mechanical spinning reel slot machine 32 dispenses or otherwise provides value (step 928) to the player. The value may be dispensed or otherwise provided as coins, paper currency, a credit on a card, a voucher indicating credit, or via electronic funds transfer.

In some cases, the controller determines that the player is entitled to an optional bonus game (step 916Y and enables bonus game play (step 918). If the controller determines that the player is not entitled to bonus game play, it enables additional slot game play for the player. The player may play again (step 924) if value input remains (step 902) or, if no value input remains, the player may deposit additional value input. If additional slot game play is not desired, a cash-out option (step 926) via the cash-out button is available to the player. Upon selection of the cash-out button, the gaming machine dispenses or otherwise provides value (step 928) to the player.

Upon completion of the bonus game, the controller determines whether the player has won (step 920). If the player has won, an award associated with the bonus game win is credited to the player as described above. If the controller determines that the player has not won, the player may chose additional slot game play. If additional slot game play is not desired, a cash-out option (step 926) via the cash-out button is available to the player. Upon selection of the cash-out button, the gaming machine dispenses or otherwise provides value (step 928) to the player.

Although discussed as having three mechanical reels, the adaptable mechanical spinning reel slot machine 32 may include additional reels. For example, the adaptable mechanical spinning reel slot machine 32 may have five spinning reels and may offer additional pay line options.

As may be apparent from the discussion above, the adaptable mechanical spinning reel slot machine 32 in the server based gaming system 10 is capable of automatic configuration and reconfiguration, including visual, non-visual and audio configuration and reconfiguration, with or without manual intervention. The configuration (and therefore operation) of the adaptable mechanical spinning reel slot machine 32 may be controlled based on feature options previously (1) downloaded from a coupled server, a coupled peer gaming machine or other suitable machine having a processor and a memory, or (2) selected by the coupled server, the coupled peer gaming machine, the other suitable machine having a processor and a memory, or the adaptable mechanical spinning reel slot machine 32. The feature options determine game aspects of the adaptable mechanical spinning reel slot machine. Selection of the feature options may be based on one of any number of triggering events such as a time of day, a day of the week, a promotional scheme, a player identity and associated preferences, and a player selection (e.g., selecting a particular themed slot game from among a number of themed slot games), to name a few.

In addition, as may be apparent from the above discussion, when coupled to a server in a server-based gaming system, an adaptable mechanical spinning reel slot machine having at least one variable display device is capable of having its appearance and operation changed with or without manual operator intervention at the slot machine. For example, feature options, when selected for mechanical spinning reel slot machine operation, may cause images on the award glass area and the reel glass display area be reconfiguration to reflect, for example, new hold percentages, new minimum bid denominations, etc. associated with a new game theme or even the same game theme. In the server-based gaming network of the invention, these reconfigurations can be made automatically by a coupled server or a peer gaming machine, or if the feature options were previously downloaded, by the adaptable mechanical spinning reel slot machine. In this way, the adaptable mechanical spinning reel slot machine can be visually reconfigured to provide a number of slot games with or without manual intervention by a technician or operator.

Further, although discussed in terms of a mechanical spinning reel slot machine, it is contemplated that the invention is applicable to other types of electro-mechanical gaming devices in a server-based gaming environment.

From the foregoing, it will be observed that numerous variations and modifications may be affected without departing from the scope of the novel concept of the invention. It is to be understood that no limitations with respect to the specific methods and apparatus illustrated herein is intended or should be inferred. It is, of course, intended to cover by the appended claims all such modifications as fall within the scope of the claims.

What is claimed is:

1. A gaming network comprising:
a coupled apparatus having a controller; and
a plurality of electro-mechanical gaming machines coupled to the coupled apparatus, each of the plurality of electro-mechanical gaming machines comprising:
a feature option configured by the controller, and
at least one electro-mechanical device.

2. The gaming network of claim 1, wherein a wagering game aspect of the plurality of electro-mechanical gaming machines is determined by the feature option.

3. The gaming network of claim 1, wherein the at least one electro-mechanical device comprises a plurality of mechanical spinning reels having reels symbols thereon.

4. The gaming network of claim 1, wherein the at least one electro-mechanical device comprises a motor driven game element.

5. The gaming network of claim 1, wherein the coupled apparatus comprises a server.

6. The gaming network of claim 1, wherein the coupled apparatus comprises a gaming machine.

7. The gaming network of claim 1, wherein the feature option resides on a memory device of at least one of the plurality of electro-mechanical gaming machines.

8. The gaming network of claim 1, wherein the feature option resides on the coupled apparatus.

9. The gaming network of claim 1, wherein the feature option is downloaded from the coupled apparatus to at least one of the plurality of electro-mechanical gaming machines.

10. The gaming network of claim 1, wherein the feature option is selected from the group consisting of a hold percentage configuration, a game play denomination configuration, a minimum wager amount configuration, a top award configuration, a bonus game scheme configuration, a player specific bonus feature configuration, a mechanical device motion profile, an electronic transfer fund configuration, a game theme configuration, a lighting configuration, a sound configuration, a harm minimization behavior configuration, and a casino float configuration.

11. A gaming network comprising:
an adaptable electro-mechanical gaming machine including at least one electro-mechanical device; and
a coupled apparatus operatively coupled to the adaptable electro-mechanical gaming machine, the coupled apparatus including a controller, the controller including a memory operatively coupled a processor, the controller being programmed to:
determine a value payout in response to detecting a wager for wagering game play on the electro-mechanical gaming machine, and
cause the electro-mechanical device to present an outcome associated with the value payout.

12. The gaming network of claim 11, wherein the at least one electro-mechanical device comprises a plurality of mechanical spinning reels having reels symbols thereon, and wherein the outcome is presented by arranging a plurality of reel symbols in an array.

13. The gaming network of claim 11, wherein the at least one electro-mechanical device comprises a motor driven game element.

14. The gaming network of claim 11, wherein the controller is further programmed to select at least one feature option from among a plurality of feature options, the at least one feature option determining a wagering game aspect of the adaptable electro-mechanical gaming machine.

15. The gaming network of claim 14, wherein the plurality of feature options reside on a storage device coupled to the adaptable electro-mechanical gaming machine.

16. The gaming network of claim 14, wherein the plurality of feature options reside on a memory device of the coupled apparatus.

17. The gaming network of claim 14, wherein the at least one feature option is selected from the group consisting of a hold percentage configuration, a game play denomination configuration, a minimum wager amount configuration, a top award configuration, a bonus game scheme configuration, a player specific bonus feature configuration, a mechanical device motion profile, an electronic transfer fund configuration, a game theme configuration, a lighting configuration, a sound configuration, a harm minimization behavior configuration, and a casino float configuration.

18. The gaming network of claim 14, further comprising a variable display device configured to display a plurality of graphics on the adaptable electro-mechanical gaming machine.

19. The gaming network of claim 18, wherein the at least one feature option is selected from the group consisting of a graphics configuration, an attract mode configuration, an advertising configuration, and a game graphic configuration.

20. The gaming network of claim 17, wherein the at least one feature option comprises the electronic transfer fund configuration, and wherein a player electronic transfer fund is established at the adaptable electro-mechanical gaming machine.

21. The gaming network of claim 17, wherein the at least one feature option comprises the electronic transfer fund configuration, and wherein a player electronic transfer fund is established at the coupled apparatus.

22. The gaming network of claim 17, wherein the controller is further programmed to modify operation of the adaptable electro-mechanical gaming machine based on the at least one of the plurality of feature options.

23. The gaming network of claim 14, wherein the selection of the at least one of the plurality of feature options by the controller is based on an occurrence of an event.

24. The gaming network of claim 23, wherein the event is selected from the group consisting of a time of day, a day of week, a promotional activity, a local activity, an identify of the player, a selection made by the player, and a selection made by a casino operator.

25. The gaming, network of claim 11, wherein the coupled apparatus comprises a server.

26. The gaming network of claim 11, wherein the coupled apparatus comprises a gaming machine.

27. The gaming network of claim 11, wherein the coupled apparatus comprises a handheld computer.

28. The gaming network of claim 11, wherein the adaptable electro-mechanical gaming device further includes a variable display device adapted to display a plurality of graphics.

29. The gaming network of claim 28, wherein the plurality of graphics is selected by the controller of the coupled apparatus.

30. The gaming network of claim 29, wherein the plurality of graphics is selected from the group consisting of an instructional information graphic, a pay line graphic, a symbol graphic, a bonus game graphic, a jackpot graphic, a special effects graphic, a game theme graphic, an attract mode graphic, an advertising graphic and a pay table graphic.

31. The gaming network of claim 30, wherein the group further consists of live video feed and recorded video.

32. The gaming network of claim 30, wherein the controller is further programmed to select the plurality of graphics displayed on the variable display device, the plurality of graphics modifying a visual appearance of the adaptable electro-mechanical gaming machine.

33. The gaming network of claim 28, wherein the variable display device comprises a flat panel transmissive display configured to overlay the plurality of graphics upon the electro-mechanical device.

34. The gaming network of claim 28, wherein the variable display device comprises a light emitting diode display.

35. The gaming network of claim 28, wherein at least one of the plurality of graphics is a virtual graphic.

36. The gaming network of claim 35, further including a partially reflective mirror at least partially overlaying the electro-mechanical device, the variable display device and the partially reflective mirror being relatively positioned such that the virtual graphic appears to be projected generally in front of the electro-mechanical device.

37. The gaming network of claim 28, wherein the variable display device is further adapted to cause an adjustment to a visual clarity of at least a portion of the plurality of graphics.

38. The gaming network of claim 37, wherein the adjustment results in a visual clarity that is generally opaque, generally translucent, or generally transparent.

39. The gaming network of claim 30, wherein the pay table graphic is selected by the controller of the coupled apparatus.

40. The gaming network of claim 28, further comprising a second variable display device adapted to display at least a second graphic on the adaptable electro-mechanical gaming device.

41. A gaming network comprising:
a coupled apparatus comprising a coupled apparatus controller, the coupled apparatus controller being programmed to select at least one feature option from among a plurality of feature options; and
an adaptable electro-mechanical gaming machine coupled to the coupled apparatus, the adaptable electro-mechanical gaming machine comprising a gaming machine controller and an electro-mechanical device, the gaming machine controller being programmed to:
cause the electro-mechanical device to present an outcome associated with a value payout, and
determine the value payout in response to detecting a wager made by a player of the adaptable electro-mechanical gaming machine.

42. The gaming network of claim 41, wherein the at least one feature option determines a wagering game aspect of the adaptable electro-mechanical gaming machine.

43. The gaming network of claim 42, wherein the electro-mechanical device comprises a plurality of mechanical spinning reels having reels symbols thereon, and wherein the outcome is presented by arranging a plurality of reel symbols in an array.

44. The gaming network of claim 42, wherein the electro-mechanical device comprises an actuator driven game element.

45. The gaming network of claim 42, wherein at least some of the plurality of feature options reside on a memory device of the adaptable electro-mechanical gaming machine.

46. The gaming network of claim 42, wherein at least some of the plurality of feature options reside on a memory device of the coupled apparatus.

47. The gaming network of claim 42, wherein the coupled apparatus comprises a server.

48. The gaming network of claim 42, wherein the coupled apparatus comprises a gaming machine.

49. The gaming network of claim 42, wherein the at least one feature option is selected from the group consisting of a hold percentage configuration, a game play denomination configuration, a minimum wager amount configuration, a top award configuration, a bonus game scheme configuration, a player specific bonus feature configuration, a mechanical device motion profile, an electronic transfer fund configuration, a game theme configuration, a lighting configuration, a sound configuration, a harm minimization behavior configuration, and a casino float configuration.

50. The gaming network of claim 49, wherein the coupled apparatus controller is further programmed to modify operation of the adaptable electro-mechanical gaming machine based on the at least one of the plurality of feature options.

51. The gaming network of claim 49, wherein the at least one feature option comprises the electronic transfer fund configuration, and wherein a player electronic transfer fund is established at the adaptable electro-mechanical gaming machine.

52. The gaming network of claim 49, wherein the at least one feature option comprises the electronic transfer fund configuration, and wherein a player electronic transfer fund is established at the coupled apparatus.

53. The gaming network of claim 49, further comprising a variable display device coupled to the gaming machine controller, the variable display device configured to display a plurality of graphics on the adaptable electro-mechanical gaming machine.

54. The gaming network of claim 53, wherein the at least one feature option is selected from the group consisting of a graphics configuration, an attract mode configuration, an advertising configuration, and a game graphic configuration.

55. The gaming network of claim 53, wherein the plurality of graphics is selected from the group consisting of an instructional information graphic, a pay line graphic, a symbol graphic, a bonus game graphic, a jackpot graphic, a special effects graphic, a game theme graphic, an attract mode graphic, an advertising graphic and a pay table graphic.

56. The gaming network of claim 55, wherein the group further consists of live video feed and recorded video.

57. The gaming network of claim 55, wherein the coupled apparatus controller is further programmed to select the plurality of graphics displayed on the variable display device, the plurality of graphics modifying a visual appearance of the adaptable electro-mechanical gaming machine.

58. The gaming network of claim 53, wherein the variable display device comprises a flat panel transmissive display configured to overlay the plurality of graphics upon the electro-mechanical device.

59. The gaming network of claim 53, wherein the variable display device comprises a light emitting diode display.

60. The gaming network of claim 41, wherein the selection of the at least one of the plurality of feature options by the coupled apparatus controller is based on an occurrence of an event.

61. The gaming network of claim 60, wherein the event is selected from the group consisting of a time of day, a day of a week, a promotional activity, a local activity, an identity of the player, a selection made by the player, and a selection made by a casino operator.

62. A method of configuring an adaptable electro-mechanical gaming machine in a networked gaming network, the method comprising:
providing a coupled apparatus including a controller;
coupling at least one adaptable electro-mechanical gaming machine to the coupled apparatus, the at least one adaptable electro-mechanical gaming machine including at least one mechanical gaming element and a feature option; and
configuring the feature option in response to a command from the controller.

63. The method of claim 62, further comprising determining, using the feature option, a game aspect of the at least one adaptable electro-mechanical gaming machine.

64. A method of conducting a wagering game on an adaptable electro-mechanical gaming machine in a networked gaming environment, the method comprising:
detecting a wager to play the wagering game;
determining a value payout; and
causing a symbol array associated with the value payout to be displayed, the value payout and the symbol array being selected by a coupled apparatus coupled to the adaptable electro-mechanical gaming machine.

65. The method of claim 64, further comprising storing at least one symbol array in an account associated with a player of the wagering game for later game play.

66. The method claim of 64, wherein the act of causing comprises rotating and stopping a plurality of symbol-bearing reels to place the symbols in the symbol array.

67. The method of claim 64, further comprising displaying a winning symbol combination in the symbol array if the value payout indicates an award to the player.

68. The method of claim 64, further comprising displaying, on the adaptable electro-mechanical gaming machine, an image selected by the coupled apparatus, the image being selected from the group consisting of instructional information graphics, pay line graphics, symbol graphics, bonus game graphics, jackpot graphics, special effects graphics, theme graphics, bonus event graphics and pay table graphics.

69. A method of conducting a wagering game on an adaptable electro-mechanical gaming machine in a networked gaming environment, the method comprising:
receiving a plurality of feature options from a coupled apparatus coupled to the adaptable electro-mechanical gaming machine;
selecting at least one of the plurality of feature options that determines a game aspect of the adaptable electro-mechanical gaming machine;
receiving a wager to play the wagering game;
determining a value payout; and
causing a symbol array associated with the value payout to be displayed.

70. The method of claim 69, wherein the act of causing comprises rotating and stopping a plurality of symbol-bearing reels to place symbols, in the symbol array.

71. The method of claim 69, wherein the feature options are selected from the group consisting of hold percentage configurations, return-to-player percentage configurations, slot game play denominations, minimum wager amounts, top award configurations, bonus award schemes, player specific bonus features, slot game theme configurations, electronic transfer fund configurations, lighting configurations, sound configurations, and images.

72. The method of claim 71, wherein the player specific bonus features include at least one stored symbol of the symbol array associated with a player of the wagering game.

73. The method of claim 69, further comprising displaying, on the adaptable electro-mechanical gaming machine, an image that at least part of which appears to be superimposed over the symbol array, the image being selected from the group consisting of instructional information graphics, pay line graphics, symbol graphics, bonus game graphics, jackpot graphics, special effects graphics, theme graphics, bonus event graphics and pay table graphics.

74. The method of claim 69, furthering comprising selecting the at least one of the plurality of feature options based on a trigger event.

75. The method of claim 74, wherein the trigger event is selected from the group consisting of a time of day, day of the week, a promotional scheme, a player identity, a player selection, and a gaming proprietor selection.

76. The method of claim 69, wherein at least one of the plurality of feature options is a player specific bonus feature that stores at least one symbol of the symbol array in an account associated with a player of the wagering game for later game play.

77. A method of conducting a wagering game on an adaptable electro-mechanical gaming machine in a networked gaming environment, the method comprising:
configuring the adaptable electro-mechanical gaming machine based on at least one of a plurality of feature options selected by a gaming device in the networked gaming environment;
receiving a wager to play the wagering game;
determining a value payout for the wagering game; and
displaying a symbol array associated with the value payout.

78. The method of claim 77, further comprising storing the at least one of plurality of feature options on a memory device of the adaptable electro-mechanical gaming machine.

79. The method of claim 76, further comprising storing the at least one of the plurality of feature options on a memory device of the gaming device.

80. The method of claim 77, further comprising downloading the plurality of feature options from the gaming device to the adaptable electro-mechanical gaming machine.

81. The method of claim 77, wherein the gaming device comprises a server.

82. The method of claim 77, wherein the gaming device comprises a gaming machine.

83. The method of claim 77, wherein the feature options are selected from the group consisting of hold percentage configurations, return-to-player percentage configurations, slot game play denominations, minimum wager amounts, top award configurations, bonus award schemes, player specific bonus features, electronic transfer fund configurations, slot game theme configurations, lighting configurations, sound configurations, and images.

84. The method of claim 83, wherein the player specific bonus features include at least one symbol of the symbol array stored in an account associated with a player of the wagering game for later use.

85. The method of claim 77, further comprising displaying on the adaptable electro-mechanical gaming machine, an image that at least part of which appears to be superimposed over the symbol array, the image being selected from the group consisting of instructional information graphics, pay line graphics, symbol graphics, bonus game graphics, jackpot graphics, special effects graphics, theme graphics, bonus event graphics and pay table graphics.

86. The method of claim 77, wherein selection of the at least one of the plurality of feature options is based on a time of day, a day of the week, a promotional scheme, a player selection, or an electro-mechanical gaming machine proprietor selection.

87. A method of conducting a wagering game on an adaptable electro-mechanical gaming machine in a networked gaming environment, the method comprising:
based on at least one of a plurality of feature options selected by a gaming device in the networked gaming environment, configuring the adaptable electro-mechanical gaming machine;
detecting a wager to play the wagering game;
determining a value payout for the wagering game; and
causing a symbol array associated with the value payout to be displayed, the value payout and the symbol array selected by a first server coupled to the adaptable electro-mechanical gaming machine.

88. The method of claim 87, further comprising storing the plurality of feature options on a memory device of the adaptable electro-mechanical gaming machine.

89. The method of claim 87, wherein at least one of the feature options includes at least one symbol of the symbol array associated with an account of a player of the wagering game.

90. The method of claim 87, further comprising downloading the plurality of feature options from the gaming device to the adaptable electro-mechanical gaming machine.

91. The method of claim 87, wherein the gaming device comprises a second server.

92. The method of claim 87, wherein the gaming device comprises a gaming machine.

93. The method of claim 87, wherein the feature options are selected from the group consisting of hold percentage configurations, return-to-player percentage configurations, slot game play denominations, minimum wager amounts, top award configurations, bonus award schemes, player specific bonus features, electronic transfer fund configurations, slot game theme configurations, lighting configurations, sound configurations, and images.

94. The method of claim 87, further comprising displaying an image on the adaptable electro-mechanical gaming machine, the image being selected from the group consisting of instructional information graphics, pay line graphics, symbol graphics, bonus game graphics, jackpot graphics, special effects graphics, theme graphics, bonus event graphics and pay table graphics.

95. The method of claim 87, wherein the at least one of a plurality of feature options associated with wagering game play are selected based on a trigger event selected from the group consisting of a time of day, day of the week, a promotional scheme, a player identity, a player selection, and a gaming proprietor selection.

96. The method of conducting a wagering game in a networked game environment, comprising:
interconnecting a first gaming network to a second gaming network; the first gaming network including at least one gaming machine coupled to a coupled apparatus;
communicating gaming data between the first gaming network and the second gaming network to the at least one gaming machine via the coupled apparatus, the gaming data, being representative of an aspect of the gaming machine.

97. The method of claim 96, wherein the gaming data includes data selected from the group consisting of gaming machine performance data, maintenance data, security data, player data, accounting data, percentage hold data, slot game play denomination data, minimum amount wager data, top award data, bonus award scheme data, lighting configuration data, sound configuration data, and game outcome data.

98. The method of claim 96, wherein the first gaming network and the second gaming network are located in the same geographic region.

99. The method of claim 96, wherein the first gaming network and the second gaming network are located in different geographic regions.

100. The method of claim 96, wherein the different geographic regions are different cities.
